(19) United States
(12) Patent Application Publication
(10) Pub. No.: US 2015/0019532 A1
(43) Pub. Date: Jan. 15, 2015

(54) IMAGE SEARCHING SCHEME

(71) Applicant: KT Corporation, Seongnam-si (KR)

(72) Inventors: Jongsung KIM, Suwon-si (KR); Jae-cheol KWON, Daejeon (KR)

(21) Appl. No.: 14/326,964

(22) Filed: Jul. 9, 2014

(30) Foreign Application Priority Data
Jul. 9, 2013 (KR) 10-2013-0080191

(51) Int. Cl. G06F 17/30

(52) U.S. Cl. CPC G06F 17/30268; G06F 17/30554
USPC 707/722; 707/736

(57) ABSTRACT

In one example embodiment, a server includes a database configured to store a plurality of images along with keywords and object characteristics of respective ones of a plurality of objects displayed in the plurality of images; a receiver configured to receive a query from an end device; an image detector configured to find, from the database, one or more images that correspond to the received query, based on the keywords; and an image provider configured to provide, to the end device, the found one or more images in descending order of the object characteristics stored along with the one or more images.

### TECHNICAL FIELD

The embodiments described herein pertain generally to an image searching scheme.

### BACKGROUND

The Internet may provide access to a wide variety of communication and data resources. Examples of such resources may include video, audio or image files; websites; books; news articles, etc. A search system may identify resources in response to a search query that may include one or more search keywords or phrases. The search system may also rank the found resources based on their relevance to the search query, and may provide search results based on likely relevance.

### SUMMARY

In one example embodiment, a server may include an image divider configured to divide an image into a plurality of areas; an object identifier configured to: extract area characteristics of respective ones of the areas, and identify a plurality of objects that are respectively displayed in the plurality of areas, based on the extracted area characteristics. The server may also include a keyword manager configured to assign a keyword to respective ones of the plurality of objects; an object manager configured to extract object characteristics of respective ones of the plurality of objects; and a database configured to store the image along with the keywords and the object characteristics of respective ones of the plurality of objects displayed in the plurality of areas in the image.

In another example embodiment, a server may include a database configured to store a plurality of images along with keywords and object characteristics of respective ones of a plurality of objects displayed in the plurality of images; a receiver configured to receive a query from an end device; an image detector configured to find, from the database, one or more images that correspond to the received query, based on the keywords; and an image provider configured to provide, to the end device, the found one or more images in descending order of the object characteristics stored along with the one or more images.

In yet another example embodiment, a method performed under control of a server may include: dividing an image into a plurality of areas; extracting area characteristics of respective ones of the areas; identifying a plurality of objects that are respectively displayed in the plurality of areas, based on the extracted area characteristics; assigning a keyword to respective ones of the plurality of objects; extracting object characteristics of respective ones of the plurality of objects; and storing the image along with the keywords and the object characteristics of the plurality of objects displayed in the plurality of areas in the image.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system in which an image searching scheme may be implemented, in accordance with various embodiments described herein;

FIG. 2 shows an illustrative example image that may be divided into multiple areas, in accordance with various embodiments described herein;

FIG. 3 shows an illustrative example database, in accordance with various embodiments described herein;

FIG. 4 shows an illustrative example image search result, in accordance with various embodiments described herein;

FIG. 5 shows an illustrative example server by which at least portions of an image searching scheme may be implemented, in accordance with various embodiments described herein;

FIG. 6 shows an example processing flow of operations by which at least portions of an image searching scheme may be implemented, in accordance with various embodiments described herein;

FIG. 7 shows another example processing flow of operations by which at least portions of an image searching scheme may be implemented, in accordance with various embodiments described herein; and

FIG. 8 shows an illustrative computing embodiment, in which any of the processes and sub-processes of an image searching scheme may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

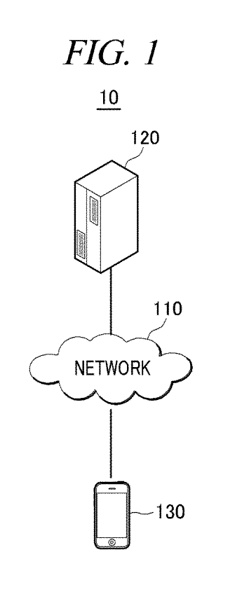

FIG. 1 shows an example system 10 in which an image searching scheme may be implemented, in accordance with various embodiments described herein. As depicted in FIG. 1, system 10 may include, at least, a server 120 and an end device 130. Server 120 and end device 130 may be communicatively connected to each other via a network 110.

Network 110 may include, as non-limiting examples, a wireless network such as a mobile radio communication network including at least one of a 3rd generation (3G), 4^{th} generation (4G), or 5^{th} generation (5G) mobile telecommunications network, various other mobile telecommunications networks, a satellite network, WiBro (Wireless Broadband Internet), Mobile WiMAX (World Interoperability for Microwave Access), HSDPA (High Speed Downlink Packet Access), Bluetooth, or the like.

Server 120 may refer to one or more servers, processing apparatuses, or computing devices hosted and/or supported by a service provider that provides image searching services to multiple end devices, including the one or more embodiments of end device 130. Server 120 may be one of multiple hosted servers, processing apparatuses, or computing devices that may be configured to receive a query from end device 130, to find one or more images corresponding to the received query, and to provide the found one or more images to end device 130 in an order of relevance to the query.

In some embodiments, server 120 may be configured to divide an image into multiple, two-dimensional areas. One or more objects may be displayed in each of the multiple areas in the image. Server 120 may be configured to divide the image into the multiple areas, based at least one of a color, texture, shape or contour of the one or more objects in respective one of the multiple areas.

As non-limiting examples of the aforementioned images, an image may be retrieved from the Internet or a cloud database that may be configured to store a variety of image data. Alternatively, the image may be received from one or more end devices including end device 130.

Server 120 may be further configured to extract area characteristics of respective ones of the multiple areas. Server 120 may be configured to extract the area characteristics of respective ones of the multiple areas, based on at least one of the color, texture, shape or contour of the areas. Server 120 may be configured to extract and/or determine the area characteristics of respective ones of the multiple areas by at least one of analyzing, calculating or filtering the color, texture, shape or contour of the areas, as will be described below. As referenced herein, the area characteristics may refer to a feature value or a feature quantity that may provide identification or distinction of each area in the image. As non-limiting examples, the area characteristics of the respective area may include at least one of color histogram, texture information or image recognition filtering result that may be associated with the respective ones of the multiple areas.

As a non-limiting example of extracting the area characteristics including the color histogram, server 120 may be configured to scan and/or analyze colors of pixels that are included in the image. Server 120 may be configured to then produce a color histogram that may include or show an average color distribution over the image, based on the scan or pixel color analysis of the image. Server 120 may be further configured to quantify and/or translate the color histogram into numerical values or degrees that may represent at least one of colors, brightness or chroma of pixels in the respective areas of the image. For example, server 120 may be configured to produce the numerical values or degrees by comparing the produced color histogram with a reference color histogram which is already stored in server 120 and shows all reference color. Server 120 may be configured to then identify respective areas of the image as having the numerical values or degrees which are in the same range (e.g., the same range of colors, brightness or chroma), and to store the numerical values or degrees of the color histogram as the area characteristics of the respective areas.

As another example of extracting the area characteristics including the texture information, server 120 may be configured to scan and/or analyze borders and/or edges of objects displayed in the respective areas and to extract texture information, based on the scans or analysis regarding the borders and/or edges of objects in the image. Server 120 may be configured to quantify and/or translate the texture information into numerical values or degrees that may represent graininess of each object in the respective areas of the image. For example, server 120 may be configured to produce the numerical values or degrees by comparing the scans or analysis result regarding the borders and/or edges of objects in the image with reference object information that may include shapes or contours of multiple objects. Server 120 may be configured to then identify respective areas of the image as having the numerical values or degrees which are in the same range (e.g., the same range of graininess), and to store the numerical values or degrees of the texture information as the area characteristics of the respective areas.

As another example of extracting the area characteristics including the image recognition filtering result, server 120 may be configured to obtain image recognition filtering result that may be associated with the respective one of the multiple areas by executing any well-known image recognition filtering technique on the respective one of the multiple areas. For example, image recognition filter may include Median Filter, Canny Filter or Gabor Filter. Further to the example, by using the Median Filter, server 120 may be configured to obtain the image recognition filtering result that may include RGB values of multiple objects displayed in the respective areas of the image. Still further to the example, by using the Canny Filter, server 120 may be configured to obtain the image recognition filtering result that may include borders and/or edges data of objects displayed in the respective areas of the image. Server 120 may be configured to then store the image recognition filtering result as the area characteristics of the respective areas of the image.

Server 120 may be further configured to identify objects that may be displayed in the divided areas of the image. Server 120 may be configured to identify objects, based on the extracted area characteristics of the respective areas in which each of the multiple objects are displayed. That is, server 120 may be configured to identify multiple objects based on at least one of the color histogram, texture information or image recognition filtering result of the respective areas in which respective objects are displayed.

Server 120 may be configured to assign a keyword to the identified respective objects. For example, server 120 may be configured to determine the keyword of the respective objects by using reference information that may include a name, colors, texture and shapes of multiple reference objects. The reference information may be stored in server 120.

Further, server 120 may be configured to extract object characteristics of the respective objects, based on at least one of a color, contour or texture of the respective objects. As referenced herein, the object characteristics may refer to a feature value or a feature quantity that may identify or otherwise distinguish each object in the image. For example, the object characteristics may include at least one of texture information or color information of respective ones of the multiple objects. The object characteristics may be extracted for respective ones of the multiple objects depending on a type of the identified respective objects. For example, but not as a limitation, server 120 may be configured to calculate blue color dimensions of an object or blue color brightness of an object of a sea or the sky. Server 120 may be further configured to identify the result of the calculation of blue color dimensions or blue color brightness (e.g., numerical value or degrees) of a sea or the sky as the object characteristics of a sea or the sky. As another example, server 120 may be configured to calculate relative degrees of grainy texture of sand. Server 120 may be further configured to identify the result of the relative degrees (e.g., numerical value or degrees) of grainy texture of sand as the object characteristics of sand.

Further, server 120 may be configured to normalize the extracted object characteristics of the respective objects based on a type of the respective identified objects. For example, server 120 may be configured to normalize the blue color dimensions or blue color brightness of the object relative to at least one of resolution of the image or size of the object in the image, if the object is a sea or the sky.

Further, the object characteristics for the respective objects may be extracted as a ratio of dimensions of each one of the respective objects relative to total dimensions of the image. For example, but not as a limitation, server 120 may be configured to calculate a ratio of a number of pixels of the respective objects in the image to a total number of pixels of the image, and to extract the ratio of pixels as the object characteristics of the respective objects.

Server 120 may be configured to store, in a database, the image along with the keywords assigned to the respective objects and the object characteristics of the respective objects displayed in the multiple areas in the image. For example, the database may be a local database or a cloud datacenter communicatively coupled to server 120 via network 110. As described above, server 120 may be configured to divide an image into multiple, two-dimensional areas; extract area characteristics of respective ones of the multiple areas; identify objects that may be displayed in the divided areas of the image; assign a keyword to the identified respective objects; and extract object characteristics of the respective objects as pre-steps or pre-functions for performing finding one or more images corresponding to a received query and providing the found one or more images, as will be described below.

Server 120 may be further configured to receive a query from end device 130 and to find one or more images that may correspond to the received query by comparing the query with the image or keywords stored in the database. That is, server 120 may be configured to find one or more images in which an object corresponding to the received query is displayed. In some embodiments, server 120 may be configured to find one or more images having one or more objects to which a keyword corresponding to the query has been assigned, if the query is a word. In some other embodiments, if the query is an image in which one or more objects are displayed, server 120 may be configured to identify the one or more objects displayed in the query image. If multiple objects are identified from the query image, server 120 may identify dimensions of the respective objects in the query image. Further, server 120 may be configured to find, from the database, multiple images corresponding to the multiple objects displayed in the query image in an order of the dimensions of the respective one of the multiple objects in the query image. For example, but not as a limitation, it may be assumed that a first object that has 70 percent dimension proportion relative to a total dimension of the query image and a second object that has 30 percent dimension proportion relative to the total dimension of the query image are displayed in the query image. Since the first object is bigger than the second object in the query image, server 120 may be configured to find, from the database, one or more images that may have an object corresponding to the first object, and next to find one or more images that may have an object corresponding to the second object.

Server 120 may be further configured to determine an order of providing the found one or more images, based on the object characteristics and/or dimensions of the object in the found one or more images, which corresponds to the received query (e.g., a keyword or an object image). Further, server 120 may be configured to provide, to end device 130, the found one or more images in the determined order. In some embodiments, server 120 may be configured to provide, to end device 130, the found one or more images in descending order of the object characteristics and/or dimensions of the object in the found one or more images.

Non-limiting examples of end device 130 may include a notebook computer, a personal computer, a smart phone, a smart television, a digital camera, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and WiBro terminal.

Thus, FIG. 1 shows an example system 10 in which an image searching scheme may be implemented, in accordance with various embodiments described herein.

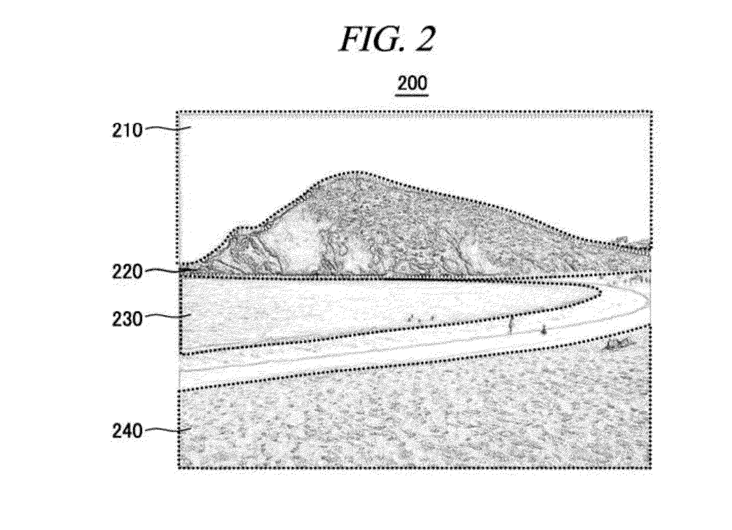

FIG. 2 shows an illustrative example image that may be divided into multiple areas, in accordance with various embodiments described herein. In some embodiments, server 120 may be configured to divide an image 200 into multiple, two-dimensional areas. Server 120 may be further configured to extract area characteristics of respective ones of the multiple areas, based at least one of a color, texture, shape contour of the respective one of the multiple areas. As non-limiting examples, the area characteristics of the respective areas may include at least one of color histogram, texture information or image recognition filtering result that may be associated with the respective ones of the multiple areas. Server 120 may be configured to extract area characteristics of respective ones of the multiple areas, based on at least one of the color, texture, shape or contour of the areas. Server 120 may be configured to extract and/or determine the area characteristics of respective ones of the multiple areas by at least one of analyzing, calculating or filtering the color, texture, shape or contour of the areas.

Further, server 120 may be configured to identify objects 210, 220, 230 and 240 that may be displayed in the divided areas of image 200. Server 120 may be configured to identify objects 210, 220, 230 and 240, based on the extracted area characteristics of the respective areas in which respective one of multiple objects 210, 220, 230 and 240 are displayed. Thus, server 120 may be configured to identify multiple objects 210, 220, 230 and 240 based on at least one of the color histogram, texture information or image recognition filtering result of respective objects in the respective areas.

Further, server 120 may be configured to assign a keyword to the objects 210, 220, 230 and 240. For example, but not as a limitation, server 120 may be configured to identify first object 210 as sky, and to assign a keyword “sky” to first object 210. Server 120 may be configured to identify second object 220 as a mountain, and to assign a keyword “mountain” to second object 220. Server 120 may be configured to identify third object 230 as sea, and to assign a keyword “sea” to third object 230. Server 120 may be configured to identify fourth object 240 as sands, and to assign a keyword “sands” to fourth object 240.

Thus, FIG. 2 shows an illustrative example image that may be divided into multiple areas, in accordance with various embodiments described herein.

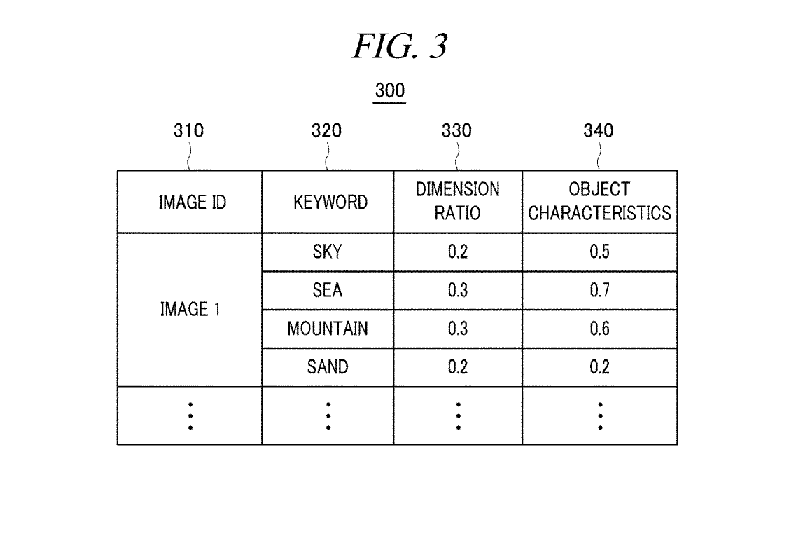

FIG. 3 shows an illustrative example database 300, in accordance with various embodiments described herein. In some embodiments, server 120 may be configured to store multiple images in a database 300. For example, but not as a limitation, as depicted in FIG. 3, server 120 may be configured to store multiple images along with image identifiers 310 of respective one of the multiple images; keywords 320 of respective ones of multiple objects displayed in the respective ones of the multiple images; dimension ratio 330 of dimensions of the respective objects relative to total dimensions of the respective ones of the multiple images; and object characteristics 340 of the respective objects displayed in the respective ones of the multiple images.

Thus, FIG. 3 shows an illustrative example database 300, in accordance with various embodiments described herein.

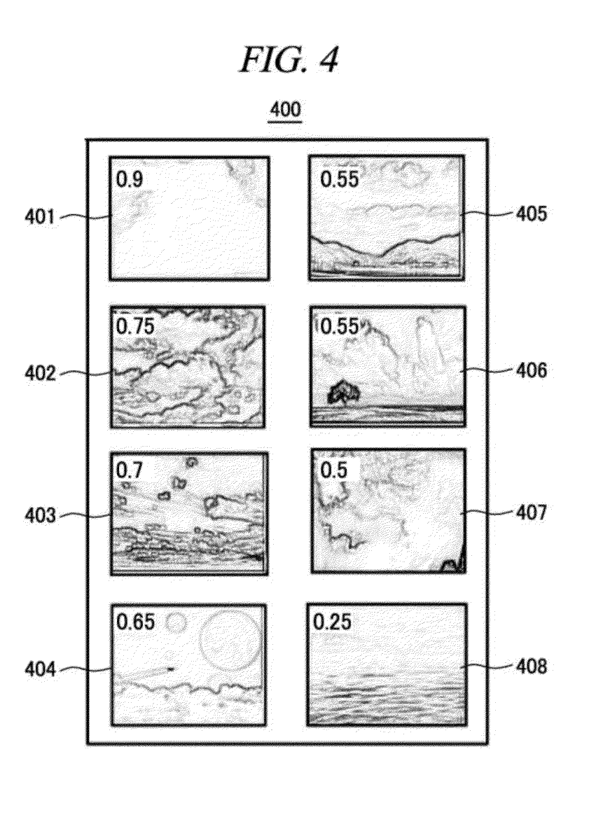

FIG. 4 shows an illustrative example image search result, in accordance with various embodiments described herein. In some embodiments, server 120 may be configured to receive a query from end device 130. For example, but not as a limitation, the query may include at least one of a word or an image. Server 120 may be configured to find one or more images that may correspond to the received query by comparing the query with images or keywords in a database. For example, server 120 may be configured to find one or more images in which an object corresponding to the received query is displayed. As depicted in FIG. 4, server 120 may be configured to find a group 400 of images 401, 402, 403, 404, 405, 406, 407 and 408, each of which has an object to which a keyword (e.g., “sky”) corresponding to a query (e.g., “sky”) has been assigned in the database.

Further, server 120 may be configured to obtain, from the database, object characteristics of the object displayed in each of images 401, 402, 403, 404, 405, 406, 407 and 408. The database may be configured to store multiple images along with keywords and object characteristics of respective ones of multiple objects displayed in the multiple images. For example, server 120 may be configured to obtain object characteristics of the object of the sky that corresponds to the query (e.g., “sky”) in each of images 401, 402, 403, 404, 405, 406, 407 and 408. For example, object characteristics of the object of the sky may be a blue color ratio or dimensions in each of images 401, 402, 403, 404, 405, 406, 407 and 408.

Further, server 120 may be configured to determine an order of providing images 401, 402, 403, 404, 405, 406, 407 and 408, based on the object characteristics of the object (e.g., “sky”) in images 401, 402, 403, 404, 405, 406, 407 and 408. Further, server 120 may be configured to provide, to end device 130, images 401, 402, 403, 404, 405, 406, 407 and 408 based on the determined order. For example, as depicted in FIG. 4, server 120 may be configured to provide, to end device 130, images 401, 402, 403, 404, 405, 406, 407 and 408 in descending order of the object characteristics of the object in images 401, 402, 403, 404, 405, 406, 407 and 408. Accordingly, server 120 may be configured to transmit, to end device 130, more accurate image search result (e.g., server 120 may provide one or more images that may include a relatively bluer sky image).

Thus, FIG. 4 shows an illustrative example image search result, in accordance with various embodiments described herein.

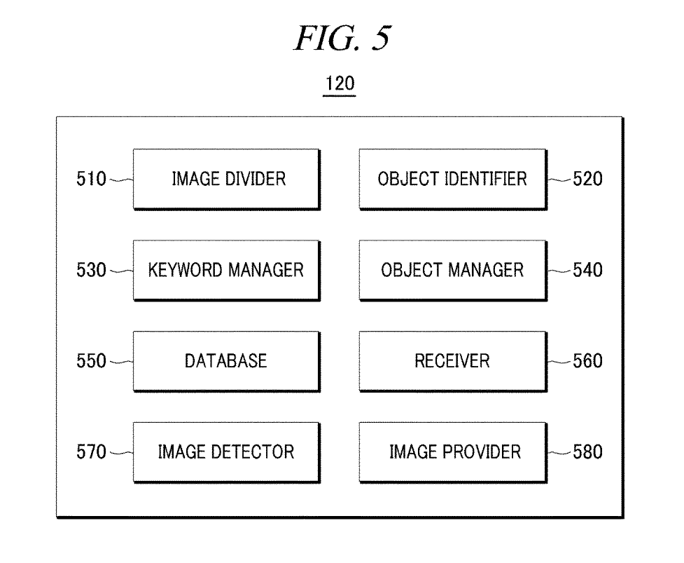

FIG. 5 shows an illustrative example server by which at least portions of an image searching scheme may be implemented, in accordance with various embodiments described herein. As depicted in FIG. 5, server 120 may include an image divider 510, an object identifier 520, a keyword manager 530, an object manager 540, a database 550, a receiver 560, an image detector 570 and an image provider 580. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of image divider 510, object identifier 520, keyword manager 530, object manager 540, database 550, receiver 560, image detector 570 and image provider 580 may be included in an instance of an application hosted on server 120.

Image divider 510 may be configured to divide an image into multiple, two-dimensional areas. In some embodiments, image divider 510 may be configured to divide each image into the multiple areas, based at least one of a color, texture, shape or contour of respective one of the multiple areas.

Object identifier 520 may be configured to extract area characteristics of respective ones of the multiple areas. Object identifier 520 may be configured to extract the area characteristics of respective ones of the multiple areas, based on at least one of the color, texture, shape or contour of the areas. Object identifier 520 may be configured to extract and/or determine the area characteristics of respective ones of the multiple areas by at least one of analyzing, calculating or filtering the color, texture, shape or contour of the areas. As non-limiting examples, the area characteristics of the respective area may include at least one of color histogram, texture information or image recognition filtering result that may be associated with the respective one of the multiple areas.

Object identifier 520 may be further configured to identify objects that may be displayed in the divided areas of the image. Object identifier 520 may be configured to identify each of the objects, based on the extracted area characteristics of the respective areas. In some embodiments, object identifier 520 may be configured to identify each of the objects displayed in respective ones of the multiple areas, based on at least one of the color histogram, texture information or image recognition filtering result of the respective areas in which respective objects are displayed.

Keyword manager 530 may be configured to assign a keyword to the identified respective objects. For example, keyword manager 530 may be configured to determine the keyword of the respective objects by using reference information that may include a name, colors, texture and shapes of multiple reference objects. The reference information may be stored in server 120.

Object manager 540 may be configured to extract object characteristics of the respective objects, based on at least one of a color, contour or texture of each one of the respective objects. For example, but not as a limitation, the object characteristics may include at least one of texture information or color information of respective ones of the multiple objects. The object characteristics may be extracted for respective ones of the multiple objects depending on a type of the identified respective objects. For example, object manager 540 may be configured to calculate blue color dimensions or blue color brightness of an object which may be a sea or the sky. Object manager 540 may be further configured to identify the result of the calculation of blue color dimensions or blue color brightness as the object characteristics of a sea or the sky. For another example, object manager 540 may be configured to calculate relative degrees of grainy texture of an object of sand. Object manager 540 may be further configured to identify the result of the relative degrees of grainy texture as the object characteristics of sand.

Further, object manager 540 may be configured to normalize the extracted object characteristics of the respective objects based on a type of the respective identified objects. For example, object manager 540 may be configured to normalize the blue color dimensions or blue color brightness of the object relative to at least one of resolution of the respective images or size of the respective objects in the respective images, if the object is a sea or the sky.

Further, the object characteristics for the respective objects may be extracted as a ratio of dimensions of each one of the multiple objects relative to total dimensions of the image. For example, but not as a limitation, object manager 540 may be configured to calculate a ratio of a number of pixels of the respective objects in the image to a total number of pixels of the image, and to extract the ratio of pixels as the object characteristics of the respective objects.

Database 550 may be configured to store multiple images. In some embodiments, database 550 may be configured to store respective one of the multiple images, along with keywords which are assigned to the respective objects displayed in the respective images; and object characteristics of the respective objects which are displayed in the multiple areas in the respective images. In some other embodiments, database 550 may be configured to store the respective one of the multiple images, further along with a ratio of dimensions of each one of the multiple objects relative to total dimensions of the respective images.

Receiver 560 may be configured to receive a query from end device 130. For example, but not as a limitation, the query may include at least one of a word or an image.

Image detector 570 may be configured to find, from database 550, one or more images that may correspond to the query received by receiver 560 by comparing the query with the image or keywords stored in database 550. That is, image detector 570 may be configured to find one or more images in which an object corresponding to the received query is displayed. In some embodiments, image detector 570 may be configured to find one or more images having one or more objects based on the keywords that are stored in database 550 and correspond to the received query.

In some other embodiments, if the query is an image in which one or more objects are displayed, image detector 570 may be configured to identify the one or more objects that are displayed in the query image received by receiver 560. Image detector 570 may be further configured to identify dimensions of the one or more objects in the query image by using any well-known image recognition methods. Further, image detector 570 may be configured to find multiple images corresponding to the one or more objects displayed in the query image in an order of the dimensions of the one or more objects displayed in the query image. For example, it may be assumed that a first object that has 70 percent dimension proportion relative to a total dimension of the query image and a second object that has 30 percent dimension proportion relative to the total dimension of the query image are displayed in the query image. Since the first object is bigger than the second object in the query image, image detector 570 may be configured to find one or more images that may have an object corresponding to the first object earlier, and next to find one or more images that may have an object corresponding to the second object.

Image provider 580 may be configured to determine an order of providing the found one or more images, based on the object characteristics and/or dimensions of the object in the found one or more images. Further, image provider 580 may be configured to provide, to end device 130, the found one or more images in descending order of the object characteristics and/or dimensions of the object, which corresponds to the received query.

Thus, FIG. 5 shows an illustrative example server by which at least portions of an image searching scheme may be implemented, in accordance with various embodiments described herein.

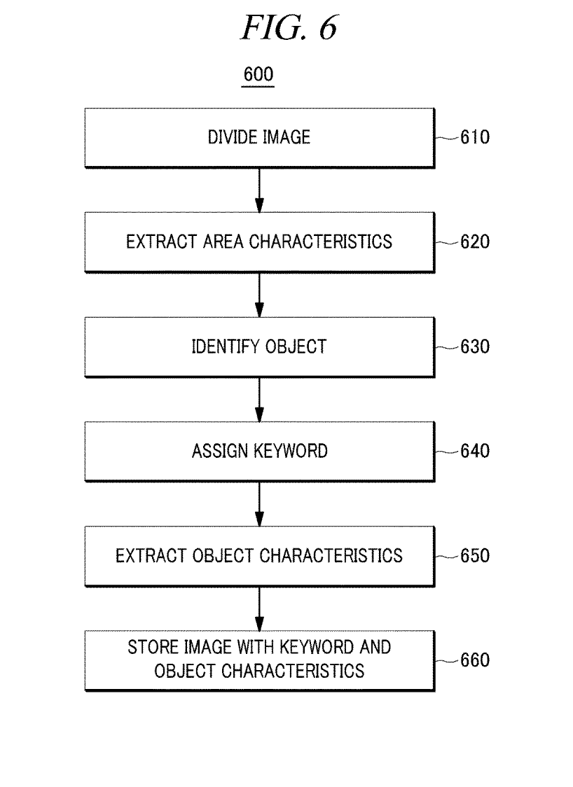

FIG. 6 shows an example processing flow of operations by which at least portions of an image searching scheme may be implemented, in accordance with various embodiments described herein. The operations of processing flow 600 may be implemented in system configuration 10 including server 120 and end device 130, as illustrated in FIG. 1. Processing flow 600 may include one or more operations, actions, or functions as illustrated by one or more blocks 610, 620,630, 640 650 and/or 660. Although illustrated as discrete blocks, various blocks may be divided into additional blocks, combined into fewer blocks, or eliminated, depending on the desired implementation. Processing may begin at block 610.

Block 610 (Divide Image) may refer to server 120 dividing an image into multiple, two-dimensional areas. In some embodiments, at block 610, server 120 may divide each image into the multiple areas, based on at least one of a color, texture, shape or contour of respective one of the multiple areas. Processing may proceed from block 610 to block 620.

Block 620 (Extract Area Characteristics) may refer to server 120 extracting area characteristics of respective ones of the multiple areas. Server 120 may extract the area characteristics of respective ones of the multiple areas, based on at least one of the color, texture, shape or contour of the areas. Server 120 may extract and/or determine the area characteristics of respective ones of the multiple areas by at least one of analyzing, calculating or filtering the color, texture, shape or contour of the areas, as will be described below. As non-limiting examples, the area characteristics of the respective area may include at least one of color histogram, texture information or image recognition filtering result that may be associated with the respective one of the multiple areas.

For example of extracting the area characteristics including the color histogram, server 120 may scan and/or analyze colors of pixels that are included in the image, and produce a color histogram that may include or show an average color distribution over the image, based on the scan or pixel color analysis of the image. Server 120 may quantify and/or translate the color histogram into numerical values or degrees that may represent at least one of colors, brightness or chroma of pixels in the respective areas of the image. For example, server 120 may produce the numerical values or degrees by comparing the produced color histogram with a reference color histogram which is already stored in server 120 and shows all reference color. Server 120 may identify and/or store the numerical values or degrees of the color histogram as the area characteristics of the respective areas.

For example of extracting the area characteristics including the texture information, server 120 may scan and/or analyze borders and/or edges of objects displayed in the respective areas, and to extract texture information based on the scans or analysis regarding the borders and/or edges of objects in the image. Server 120 may quantify and/or translate the texture information into numerical values or degrees that may represent graininess of each object in the respective areas of the image. For example, server 120 may produce the numerical values or degrees by comparing the scans or analysis result regarding the borders and/or edges of objects in the image with reference object information that may include shapes or contours of multiple objects. Server 120 may identify and/or store the numerical values or degrees of the texture information as the area characteristics of the respective areas.

For example of extracting the area characteristics including the image recognition filtering result, server 120 may obtain image recognition filtering result that may be associated with the respective one of the multiple areas by executing any well-known image recognition filtering technique on the respective one of the multiple areas. For example, image recognition filtering technique may include Median Filter, Canny Filter or Gabor Filter. Further to the example, by using the Median Filter, server 120 may obtain the image recognition filtering result that may include RGB values of multiple objects displayed in the respective areas of the image. Server 120 may store the image recognition filtering result as the area characteristics of the respective areas. Processing may proceed from block 620 to block 630.

At block 630 (Identify Object) may refer to server 120 identifying objects that may be displayed in the divided areas of the image. At block 630, server 120 may identify each of the multiple objects, based on the extracted area characteristics of the respective areas in which each of the multiple objects are displayed. In some embodiments, server 120 may identify each of the multiple objects displayed in respective ones of the multiple areas, based on at least one of the color histogram, texture information or image recognition filtering result of the respective areas in which respective objects are displayed. Processing may proceed from block 630 to block 640.

At block 640 (Assign Keyword) may refer to server 120 assigning keywords to the respective objects displayed in respective ones of the multiple areas. For example, server 120 may determine the keyword of the respective objects by using reference information that may include a name or a keyword, colors, texture and shapes of multiple reference objects. The reference information may be stored in server 120. Processing may proceed from block 640 to block 650.

At block 650 (Extract Object Characteristics) may refer to server 120 extracting object characteristics of the respective objects, based on at least one of a color, contour or texture of each of the objects. For example, the object characteristics may include at least one of texture information or color information of respective ones of the multiple objects. The object characteristics may be extracted for respective ones of the multiple objects depending on a type of the identified respective objects. For example, but not as a limitation, server 120 may calculate blue color dimensions of an object or blue color brightness of an object of a sea or the sky. Server 120 may further extract the object characteristics of a sea or the sky as a result of the calculation of blue color dimensions or blue color brightness. As another example, server 120 may calculate relative degrees of grainy texture of an object of sand. Server 120 may further extract the object characteristics of sand as a result of the relative degrees of grainy texture.

Further, at block 650, server 120 may normalize the extracted object characteristics of the respective objects based on a type of the respective identified objects. For example, server 120 may normalize the blue color dimensions or blue color brightness of the object relative to at least one of resolution of the respective images or size of the respective objects in the respective images, if the object is a sea or the sky.

Further, the object characteristics for each one of the respective objects may be extracted as a ratio of dimensions of each one of the multiple objects relative to total dimensions of the image. For example, server 120 may calculate a ratio of a number of pixels of the respective objects in the image to a total number of pixels of the image, and may extract the ratio of pixels as the object characteristics. Processing may proceed from block 650 to block 660.

Block 660 (Store Image with Keyword and Object Characteristics) may refer to server 120 storing multiple images, along with the keywords assigned to the respective objects displayed in the respective ones of the multiple images; and the object characteristics of the respective objects displayed in the respective ones of the multiple images. Further, at block 660, server 120 may store the respective one of the multiple images further along with a ratio of dimensions of the respective ones of the multiple objects relative to total dimensions of the respective ones of the multiple images.

Thus, FIG. 6 shows an example processing flow of operations by which at least portions of an image searching scheme may be implemented, in accordance with various embodiments described herein.

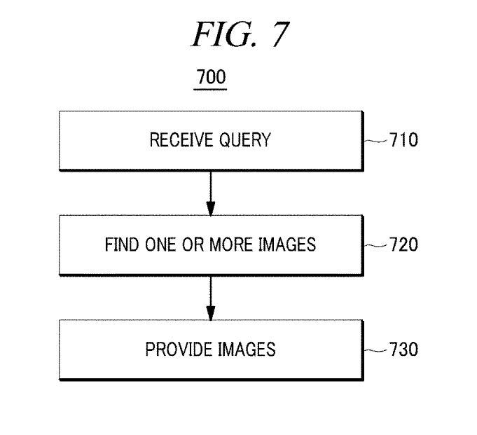

FIG. 7 shows another example processing flow of operations by which at least portions of an image searching scheme may be implemented, in accordance with various embodiments described herein. The operations of processing flow 700 may be implemented in system configuration 10 including server 120 and end device 130, as illustrated in FIG. 1. Processing flow 600 may include one or more operations, actions, or functions as illustrated by one or more blocks 710, 720 and/or 730. Although illustrated as discrete blocks, various blocks may be divided into additional blocks, combined into fewer blocks, or eliminated, depending on the desired implementation. Processing may begin at block 710.

Block 710 (Receive Query) may refer to server 120 receiving a query from end device 130. For example, but not as a limitation, the query may include at least one of a word or an image in which one or more objects are displayed. Processing may proceed from block 710 to block 720.

Block 720 (Find One or More Images) may refer to server 120 finding one or more images that may correspond to the query received at block 710 by comparing the received query with images or keywords stored in a database of server 120. Server 120 may find one or more images in which an object corresponding to the received query is displayed. In some embodiments, server 120 may find multiple images having one or more objects based on keywords that correspond to the received query. The keywords may be stored in the database, along with the one or more images.

In some other embodiments, if the query is an image in which one or more objects are displayed, server 120 may identify the one or more objects that are displayed in the query image received at block 710. Server 120 may further identify dimensions of the respective ones of the objects in the query image. Further, server 120 may find multiple images corresponding to the one or more objects displayed in the query image in an order of the dimensions of the one or more objects displayed in the query image. For example, it may be assumed that a first object that has 70 percent dimension proportion relative to a total dimension of the query image and a second object that has 30 percent dimension proportion relative to the total dimension of the query image are displayed in the query image. Since the first object is bigger than the second object in the query image, server 120 may find one or more images that may have an object corresponding to the first object, and next may find one or more images that may have an object corresponding to the second object. Processing may proceed from block 720 to block 730.

At block 730 (Provide Images) may refer to server 120 providing, to end device 130, the one or more images found at block 720. At block 730, server 120 may determine an order of providing the found one or more images, based on the object characteristics and/or dimensions of the object in the found one or more images. Further, server 120 may provide, to end device 130, the found one or more images in descending order of the object characteristics and/or dimensions of the object, which corresponds to the received query.

Thus, FIG. 7 shows another example processing flow of operations by which at least portions of an image searching scheme may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

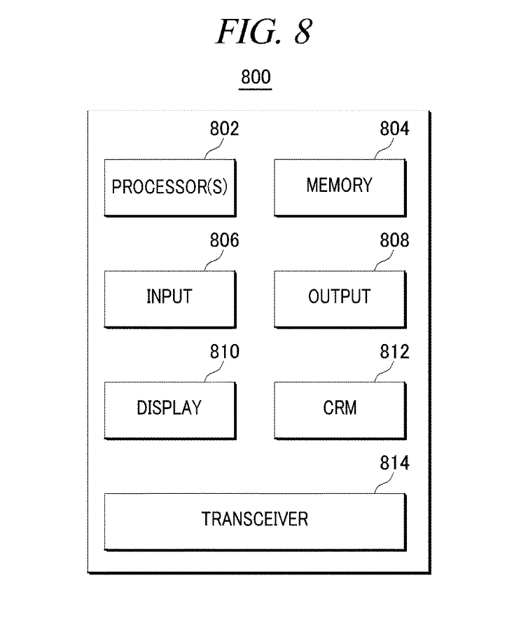

FIG. 8 shows an illustrative computing embodiment, in which any of the processes and sub-processes of an image searching scheme may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 800 may typically include, at least, one or more processors 802, a system memory 804, one or more input components 806, one or more output components 808, a display component 810, a computer-readable medium 812, and a transceiver 814.

Processor 802 may refer to, e.g., a microprocessor, a microcontroller, a digital signal processor, or any combination thereof.

Memory 804 may refer to, e.g., a volatile memory, non-volatile memory, or any combination thereof. Memory 804 may store, therein, an operating system, an application, and/or program data. That is, memory 804 may store executable instructions to implement any of the functions or operations described above and, therefore, memory 804 may be regarded as a computer-readable medium.

Input component 806 may refer to a built-in or communicatively coupled keyboard, touch screen, or telecommunication device. Alternatively, input component 806 may include a microphone that is configured, in cooperation with a voice-recognition program that may be stored in memory 804, to receive voice commands from a user of computing device 800. Further, input component 806, if not built-in to computing device 800, may be communicatively coupled thereto via short-range communication protocols including, but not limitation, radio frequency or Bluetooth.

Output component 808 may refer to a component or module, built-in or removable from computing device 800, that is configured to output commands and data to an external device.

Display component 810 may refer to, e.g., a solid state display that may have touch input capabilities. That is, display component 810 may include capabilities that may be shared with or replace those of input component 806.

Computer-readable medium 812 may refer to a separable machine readable medium that is configured to store one or more programs that embody any of the functions or operations described above. That is, computer-readable medium 812, which may be received into or otherwise connected to a drive component of computing device 800, may store executable instructions to implement any of the functions or operations described above. These instructions may be complimentary or otherwise independent of those stored by memory 804.

Transceiver 814 may refer to a network communication link for computing device 800, configured as a wired network or direct-wired connection. Alternatively, transceiver 814 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A server, comprising:
an image divider configured to divide an image into a plurality of areas;
an object identifier configured to:
extract area characteristics of respective ones of the areas, and
identify a plurality of objects that are respectively displayed in the plurality of areas, based on the extracted area characteristics;
a keyword manager configured to assign a keyword to respective ones of the plurality of objects;
an object manager configured to extract object characteristics of respective ones of the plurality of objects; and
a database configured to store the image along with the keywords and the object characteristics of respective ones of the plurality of objects displayed in the plurality of areas in the image.

2. The server of claim 1, wherein the object characteristics for each one of the respective plurality of objects are extracted as a ratio of dimensions of each one of the respective plurality of objects to total dimensions of the image.

3. The server of claim 1, wherein the object characteristics are extracted for respective ones of the plurality of objects depending on a type of the identified respective one object.

4. The server of claim 1, wherein the object manager is configured to extract the object characteristics that include at least one of texture information or color information of respective ones of the plurality of objects, based on at least one of a color, contour or texture of each one of the respective plurality of objects, and
wherein the object manager is further configured to normalize the object characteristics based on a type of the identified respective one object.

5. The server of claim 1, further comprising:
a receiver configured to receive a query from an end device;
an image detector configured to find, from the database, a plurality of images that correspond to the received query, based on the keywords stored along with the plurality of images; and
an image provider configured to provide, to the end device, the found plurality of images in descending order of the object characteristics stored along with the plurality of images.

6. The server of claim 5, wherein the query includes at least one of a word or an image.

7. The server of claim 1, wherein the image divider is configured to divide the image into the plurality of areas, based at least one of a color, texture, shape or contour of the areas.

8. The server of claim 1, wherein the object identifier is configured to extract the area characteristics that include at least one of color histogram, texture information or image recognition filtering result associated with each respective one of the plurality of areas, based on at least one of a color, texture, shape or contour of the areas.

9. A server, comprising:
a database configured to store a plurality of images along with keywords and object characteristics of respective ones of a plurality of objects displayed in the plurality of images;
a receiver configured to receive a query from an end device;
an image detector configured to find, from the database, one or more images that correspond to the received query, based on the keywords; and
an image provider configured to provide, to the end device, the found one or more images in descending order of the object characteristics stored along with the one or more images.

10. The server of claim 9, further comprising:
an image divider configured to divide each of the images into a plurality of areas; and
an object identifier configured to:
extract area characteristics of respective ones of the areas, and
identify the plurality of objects that are respectively displayed in the plurality of areas, based on the extracted area characteristics.

11. The server of claim 10, further comprising:
an object manager configured to:
extract the object characteristics that include at least one of texture information or color information of respective ones of the plurality of objects, based on at least one of a color, contour or texture of each one of the respective plurality of objects, and
normalize the object characteristics based on a type of the identified respective one of the plurality of objects.

12. The server of claim 10, wherein the object identifier is configured to extract the area characteristics that include at least one of color histogram, texture information or image recognition filtering result associated with each respective one of the plurality of areas, based on at least one of a color, texture, shape or contour of the areas.

13. The server of claim 9, wherein the object characteristics for each one of the respective plurality of objects are extracted as a ratio of dimensions of each one of the respective plurality of objects to total dimensions of each of the images.

14. The server of claim 9, wherein the object characteristics are extracted for respective ones of the plurality of objects depending on a type of the identified respective one object.

15. The server of claim 9, wherein the query includes at least one of a word or an image.

16. A method performed under control of a server, comprising:
dividing an image into a plurality of areas;
extracting area characteristics of respective ones of the areas;
identifying a plurality of objects that are respectively displayed in the plurality of areas, based on the extracted area characteristics;
assigning a keyword to respective ones of the plurality of objects;
extracting object characteristics of respective ones of the plurality of objects; and
storing the image along with the keywords and the object characteristics of the plurality of objects displayed in the plurality of areas in the image.

17. The method of claim 16, further comprising:
receiving a query from an end device;
finding one or more images that correspond to the received query, based on the keywords; and
providing, to the end device, the found one or more images in descending order of object characteristics stored along with the one or more images.

18. The method of claim 16, wherein the object characteristics for each one of the respective plurality of objects are extracted as a ratio of dimensions of each one of the respective plurality of objects to total dimensions of the image.

19. The method of claim 16, wherein the dividing of the image is based at least one of a color, texture, shape or contour of the areas.

20. The method of claim 16, wherein the object characteristics for each one of the respective plurality of objects are extracted based on at least one of a color, contour or texture of each one of the respective plurality of objects, and
wherein the object characteristics are normalized based on a type of the identified respective ones of the plurality of objects.
